(19) United States
(12) Patent Application Publication
(10) Pub. No.: US 2020/0159161 A1
(43) Pub. Date: May 21, 2020

(54) IMAGE FORMING APPARATUS

(71) Applicant: KONICA MINOLTA, INC., Tokyo (JP)

(72) Inventors: Eriko KOZAKI, Tokyo (JP); Shinichi KAWABATA, Tokyo (JP)

(73) Assignee: KONICA MINOLTA, INC., Tokyo (JP)

(21) Appl. No.: 16/673,778

(22) Filed: Nov. 4, 2019

(30) Foreign Application Priority Data
Nov. 19, 2018 (JP) 2018-216609

(51) Int. Cl. G03G 21/00; G03G 15/00

(52) U.S. Cl. CPC G03G 21/0052; G03G 2221/0094; G03G 15/5016

(57) ABSTRACT

An image forming apparatus includes: a band electrode that electrically charges a surface of a photoreceptor, the band electrode being disposed along an axial direction of the photoreceptor, a suction port that sucks air and ejects a discharge product generated at the band electrode; and a first blowing port that blows air, wherein the air blown from the first blowing port flows along the band electrode from one end of the band electrode toward the other end, and is sucked through the suction port.

The entire disclosure of Japanese patent Application No. 2018-216609, filed on Nov. 19, 2018, is incorporated herein by reference in its entirety.

### BACKGROUND

### Technological Field

The present invention relates to an image forming apparatus.

### Description of the Related Art

In an image forming apparatus using an electrophotographic process, the surface of a photoreceptor is electrically charged by a charging device, and the surface of the photoreceptor is irradiated with (exposed to) laser light based on image data, so that an electrostatic latent image is formed. As toner is supplied to the photoreceptor from a developing device, the electrostatic latent image is visualized, and a toner image is formed. The toner image is directly or indirectly transferred onto a paper sheet and is then fixed. Thus, an image is formed on the paper sheet.

The charging device includes a band electrode maintained at a predetermined potential, and electrically charges the photoreceptor by discharging. With this discharge, discharge products such as ozone and nitrogen oxide are generated around the band electrode. Since discharge products become the cause of image defects, a technique has been developed to counter that. According to this known technique, a suction port is disposed in the vicinity of a band electrode, and air is sucked through the suction port to collect the discharge products generated at the band electrode.

For example, JP 2005-127172 A discloses a structure that sucks air through an axial fan, and blows the air to a corona charger through a duct, because corona products generated from ozone adversely affect the photosensitive drum. Particularly. JP 2005-127172 A adopts a structure that blows air uniformly onto the entire region of a band electrode extending in the axial direction of a photoreceptor.

As the processing speed has increased, the amount of current to be applied to a band electrode has also increased. Therefore, discharge product generation also tends to increase. Because of this, there is a problem that discharge products are not sucked in regions located far from a suction port.

Meanwhile, the technique disclosed in JP 2005-127172 A involves a structure in which the blowing port of a duct faces the entire region of a band electrode. Therefore, a large space is required for disposing ducts, and it is difficult to reduce the size of the image forming apparatus.

### SUMMARY

The present invention has been made in view of such circumstances, and an object of the present invention is to provide an image forming apparatus capable of efficiently collecting discharge products, while reducing the size of the image forming apparatus.

To achieve the abovementioned object, according to an aspect of the present invention, an image forming apparatus reflecting one aspect of the present invention comprises: a band electrode that electrically charges a surface of a photoreceptor, the band electrode being disposed along an axial direction of the photoreceptor, a suction port that sucks air and ejects a discharge product generated at the band electrode: and a first blowing port that blows air, wherein the air blown from the first blowing port flows along the band electrode from one end of the band electrode toward the other end, and is sucked through the suction port.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a configuration diagram schematically showing an image forming apparatus according to an embodiment;

FIG. 2 is an explanatory diagram schematically showing the configuration of a charging device and its surroundings,

FIG. 3 is an explanatory diagram schematically showing a cross-section taken along the A-A line defined in FIG. 2:

FIG. 4 is an explanatory diagram showing the relationship between a shield case and a photosensitive drum;

FIG. 5 is an explanatory diagram showing four image formers and the flow in the collection of discharge products;

FIG. 6 is a diagram for explaining a switching gate that switches the ratio between a first flow and a second flow; and

FIG. 7 shows a table for explaining the ratio between the first flow and the second flow depending on the conditions for operating an image forming apparatus.

### DETAILED DESCRIPTION OF EMBODIMENTS

Hereinafter, one or more embodiments of the present invention will be described with reference to the drawings. However, the scope of the invention is not limited to the disclosed embodiments.

### First Embodiment

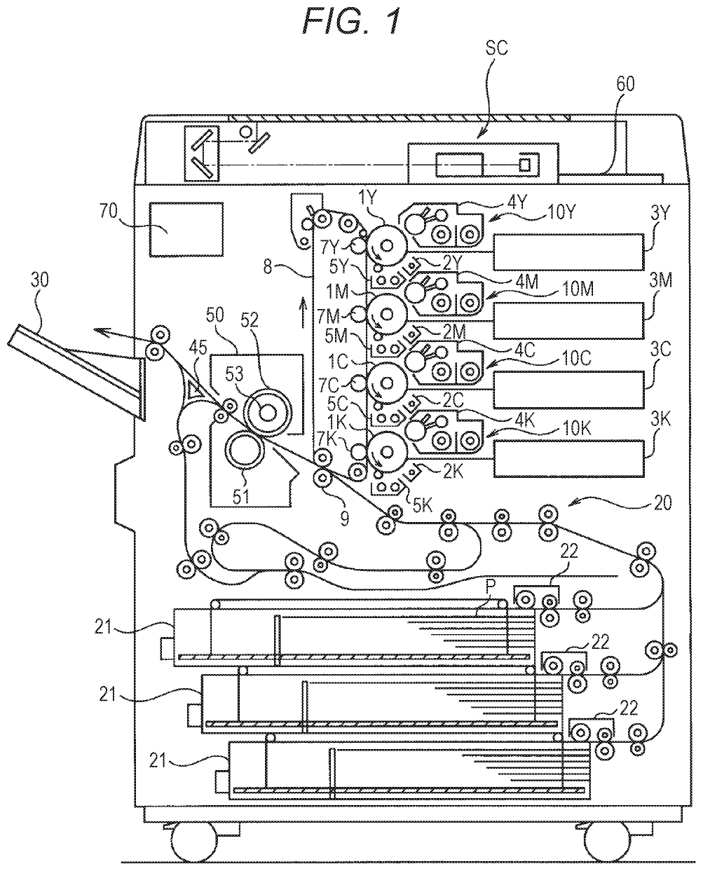

FIG. 1 is a configuration diagram schematically showing an image forming apparatus according to this embodiment. The image forming apparatus according to this embodiment is an electrophotographic image forming apparatus, for example, and is a so-called tandem color image forming apparatus that forms full-color images.

The image forming apparatus includes a document reading device SC, four image formers 10Y, 10M, 10C, and 10K, a sheet conveyor 20, a fixing device 50, and a controller 70 as its principal components.

The document reading device SC illuminates an image of a document with an illumination device, and obtains an image signal by reading the reflected light with a line image sensor. The image signal is subjected to processing such as A/D conversion, shading correction and compression, and is then input as image data to the controller 70. The image data to be input to the controller 70 is not necessarily data read by the document reading device SC, but may be data received from a personal computer connected to the image forming apparatus or another image forming apparatus, or data read from a portable recording medium such as a USB memory, for example.

The image formers 10Y 10M, 10C, and 10K are the image former 10Y that forms a yellow (Y) image, the image former 10M that forms a magenta (M) image, the image former 10C that forms a cyan (C) image, and the image former 10K that forms a black (K) image. The four image formers 10Y, 10M, 10C, and 10K are arranged from the upstream side to the downstream side in the moving direction (traveling direction) of an intermediate transfer belt 8 while facing the intermediate transfer belt 8 that is an endless belt. Of the four image formers 10Y, 10M, 10C, and 10K, the yellow image former 10Y is located on the most upstream side, the magenta image former 10M and the cyan image former 10C are located in this order in the direction toward the downstream side, and the black image former 10K is located on the most downstream side.

The image former 10Y includes a photosensitive drum 1Y, a and a charging device 2Y, an optical writing unit 3Y, a developing device 4Y, and a drum cleaner 5Y, which are disposed around the photosensitive drum 1Y. The surface (photosensitive surface) of the photosensitive drum 1Y is uniformly charged by the charging device 2Y, and a latent image is formed on the photosensitive drum 1Y by the optical writing unit 3Y performing scanning exposure. The developing device 4Y performs development with toner, to visualize the latent image on the photosensitive drum 1Y. As a result, an image (a toner image) corresponding to yellow is formed on the photosensitive drum 1Y. Images formed on the photosensitive drum 1Y are transferred one by one to a predetermined position on the intermediate transfer belt 8 by a primary transfer roller 7Y.

The image formers 10M, 10C, and 10K include photosensitive drums 1M, 1C, and 1K, and charging devices 2M, 2C, and 2K, optical writing units 3M, 3C, and 3K, developing devices 4M, 4C, and 4K, and drum cleaners 5M, 5C, and 5K, which are arranged around the photosensitive drums 1M, 1C, and 1K. The details of these components are the same as those of the image former 10Y.

The intermediate transfer belt 8 is stretched around a plurality of rollers including a secondary transfer counter roller, the primary transfer rollers 7Y, 7M, 7C, and 7K, and a driven roller. An image transferred onto the intermediate transfer belt 8 is transferred by a secondary transfer roller 9 onto a paper sheet P being conveyed at a predetermined time by a sheet conveyor 20. The secondary transfer roller 9 is pressed against the secondary transfer counter roller via the intermediate transfer belt 8.

The sheet conveyor 20 conveys paper sheets P along a conveyance path. The paper sheets P are stored in sheet trays 21, and the paper sheets P stored in the sheet trays 21 are taken in by sheet feeder units 22 and are sent into the conveyance path. A plurality of conveyance rollers that convey the paper sheets P is disposed in the conveyance path.

The fixing device 50 performs a fixing process for fixing a transferred image onto a paper sheet P. The fixing device 50 includes a pair of fixing rollers 51 and 52 that are disposed in pressure contact with each other to form a nip (a fixing nip), and a heating unit 53 that heats the fixing roller 52 corresponding to the surface onto which the image is transferred. A heater such as a halogen lamp can be used as the heating unit 53. The fixing device 50 conveys the paper sheet P, and performs pressure fixing with the pair of fixing rollers 51 and 52 and thermal fixing with the heating unit 53, so that the image is fixed onto the paper sheet P.

The paper sheet P subjected to the fixing process passes through the conveyance path on the downstream side of the fixing nip, and is ejected onto a sheet catch tray 30 attached to a side surface of the housing. In a case where image formation is also performed on the back side of the paper sheet P, a switching gate 45 is switched to send the paper sheet P, on which the image formation on the front surface has been performed, into a reverse conveyance path for reversing the paper sheet P and then conveying the paper sheet P to the upstream side of the conveyance path.

An operation panel 60 is a touch panel input unit capable of performing an input operation in accordance with information displayed on a display. By operating the operation panel 60, the user can make settings relating to a print job, such as information about the paper sheets P (the paper type and the like), image density, magnification, and the like. The set information is acquired by the controller 70. Under the control of the controller 70, the operation panel 60 also displays various kinds of information to the user via the operation panel 60.

The controller 70 performs control relating to the image forming apparatus. The controller 70 may be formed with a microcomputer that includes a CPU, a ROM, a RAM, and an input/output interface as its principal components. The CPU (a processor) executes various kinds of programs. The ROM stores the various kinds of programs to be executed by the CPU, in the form of program codes that can be read by the CPU. The ROM also stores the data necessary for executing the programs. The RAM is the memory that serves as a work storage area. The programs and the data stored in the ROM are read by the CPU, and are loaded into the RAM. In accordance with the programs and the data loaded into the RAM, the CPU performs various kinds of processes.

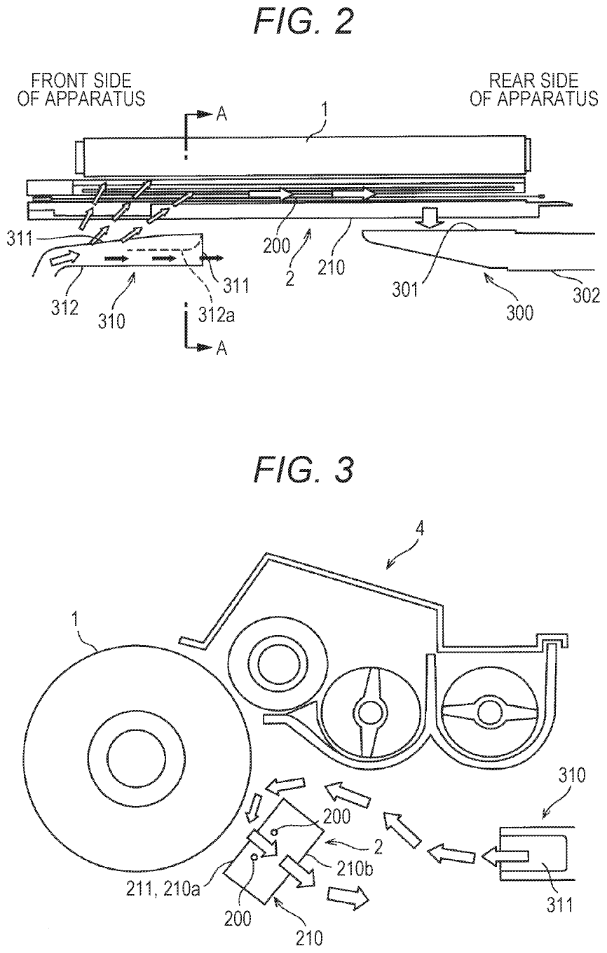

FIG. 2 is an explanatory diagram schematically showing the configuration of a charging device 2 and its surroundings. FIG. 3 is an explanatory diagram schematically showing a cross-section taken along the A-A line defined in FIG. 2. In the description below, a charging device 2 represents each of the charging devices 2Y, 2M, 2C, and 2K included in the four image formers 10Y, 10M, 10C, and 10K. A photosensitive drum 1 represents each of the photosensitive drums 1Y, 1M, 1C, and 1K in the four image formers 10Y, 10M, 10C, and 10K. Likewise, a developing device 4 represents each of the developing devices 4Y. 4M. 4C, and 4K in the four image formers 10Y, 10M, 10C, and 10K.

The charging device 2 includes band electrodes 200 and a shield case 210 as its principal components.

A predetermined voltage is applied to the band electrodes 200, so that the band electrodes 200 perform corona discharge onto the photosensitive surface of the photosensitive drum 1. To cope with an increase in processing speed, the charging device 2 of this embodiment includes two band electrodes 200.

The shield case 210 is made of a conductive material such as stainless steel, and is a substantially rectangular parallelepiped box, for example. The shield case 210 is disposed, with its longitudinal direction being parallel to the axial direction of the photosensitive drum 1. The shield case 210 is detachably attached to the image forming apparatus, and the entire charging device 2 is replaceable.

In the shield case 210, the two band electrodes 200 are supported in a stretched state. Specifically, both ends of each band electrode 200 are attached to the shield case 210. Each band electrode 200 is disposed in parallel with the axial direction of the photosensitive drum 1, and the two band electrodes 200 are arranged at a predetermined distance from each other. Each band electrode 200 is formed with a wire made of tungsten, for example, and its surfaces are plated with gold.

In the shield case 210, almost the entire area of the front surface portion 210a facing the photosensitive surface of the photosensitive drum 1 is opened, to form a charging opening 211.

The entire charging opening 211 is covered with a grid (not shown) for performing corona discharge of the band electrode 200 uniformly on the photosensitive surface of the photosensitive drum 1. The grid is in the form of a plate or a sheet. The grid is formed with a conductive member, such as stainless steel, and has a mesh structure having laser processing or etching processing performed on almost its entire region.

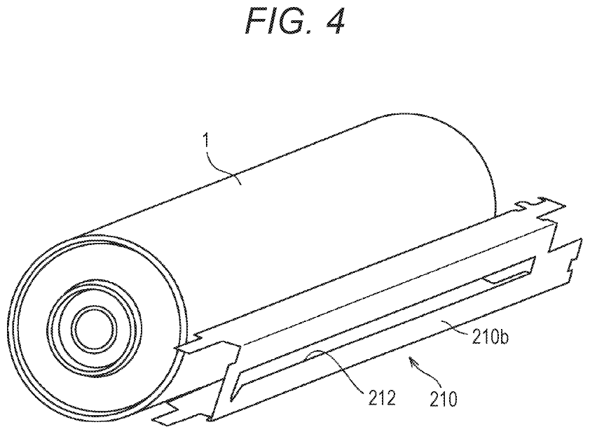

FIG. 4 is an explanatory diagram showing the relationship between the shield case 210 and the photosensitive drum 1. A slit 212 that is horizontally long in the axial direction of the photosensitive drum 1 is formed in the back surface portion 210b of the shield case 210. As air passes through the back surface portion 210b via the slit 212, discharge products such as ozone generated by the discharging of the band electrodes 200 are collected without staying around the band electrodes 200.

Around the band electrodes 200, a suction duct 300 and a blowing duct 310 are disposed.

The suction duct 300 includes a suction port 301 and a suction duct main body 302 as its principal components. The suction port 301 sucks air, to eject the discharge products generated at the band electrodes 200. The suction port 301 is located at an end of the suction duct main body 302. The suction duct main body 302 forms a channel that guides air sucked from the suction port 301 to the downstream side. A suction fan (not shown) for sucking air from the suction port 301, a separator (not shown) for separating ozone collected by the air, and an activated carbon filter (not shown) for decomposing the separated ozone are provided on the downstream side of the suction duct main body 302.

The blowing duct 310 includes a blowing port 311 and a blowing duct main body 312 as its principal components. The blowing port 311 blows air toward a target object. The blowing port 311 is located at an end of the blowing duct main body 312. The blowing duct main body 312 guides air blown from the blowing port 311. A blast fan for blowing air from the blowing port 311 is provided on the upstream side of the blowing duct main body 312.

The blowing port 311 has a function of cooling a polygon motor (not shown), and air blown from the blowing port 311 is guided to the polygon motor (not shown). Here, the polygon motor is a motor that rotationally drives a polygon mirror (not shown) to scan light on the photosensitive drum 1 electrically charged by the band electrodes 200.

The blowing duct 310 also has a function of collecting discharge products, and air blown from the blowing port 311 is guided to the band electrode 200 to collect the discharge products. That is, air blown from the blowing port 311 includes a first flow (indicated by white arrows in the drawings) toward the band electrodes 200, and a second flow (indicated by black arrows in the drawing) toward the polygon motor to cool the polygon motor. In the blowing duct main body 312, a guide member 312a for dividing the air flowing in the blowing duct main body 312 into the first flow and the second flow is provided.

In this embodiment, the blowing port 311 is provided at one end of each band electrode 200, or at the end located on the front side of the apparatus, for example. The blowing port 311 is designed so that the first flow toward the band electrodes 200 become oblique to the band electrodes 200. On the other hand, the suction port 301 is provided at the other end of each band electrode 200, or at the end located on the rear side of the apparatus, for example.

Because of the layout of the suction port 301 and the blowing port 311, air blown from the blowing port 311 (the first flow) flows along the band electrodes 200 from the one end (the front side of the apparatus) to the other end (the rear side of the apparatus), and is sucked through the suction port 301. Accordingly, air is not only sucked at the rear side of the apparatus but also blown from the front side of the apparatus, so that the discharge products staying on the band electrodes 200 can be appropriately collected.

The slit 212 is further formed in the back surface portion 210b of the shield case 210. With this arrangement, air that is blown from the blowing port 311 and is flowing along the band electrodes 200 reaches the surface of the photosensitive drum 1 beyond the shield case 210, and changes its direction from there. The air then flows toward the charging opening 211 of the shield case 210, passes through the inside of the shield case 210, and then flows to the outside of the shield case 210 through the slit 212. Thus, the discharge products staying on the band electrodes 200 can be appropriately collected.

Further, one or both of the opening area and the wind speed are set so that the suction air volume at the suction port 301 becomes equal to or larger than the blowing air volume at the blowing port 311. As the suction air volume at the suction port 301 is equal to or larger than the blowing air volume at the blowing port 311, the air (the first flow) blown from the blowing port 311 is sucked through the blowing port 311 without staying in the apparatus. Thus, discharge products can be efficiently collected.

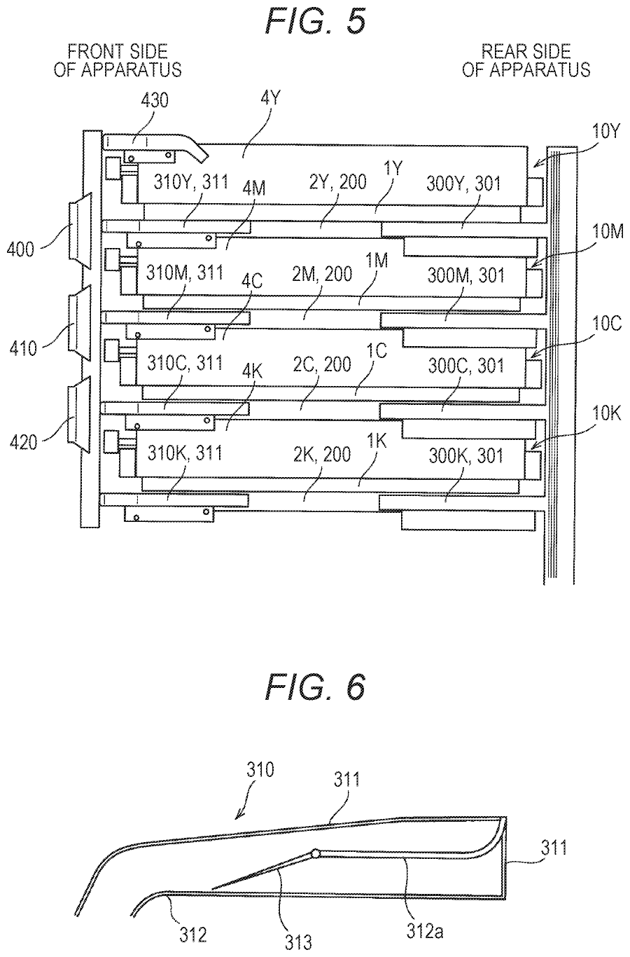

FIG. 5 is an explanatory diagram showing the four image formers 10Y, 10M, 10C, and 10K, and the flow in the collection of discharge products. The four image formers 10Y, 10M, 10C, and 10K are equipped with suction ducts 300Y, 300M, 300C, and 300K, and blowing ducts 310Y, 310M, 310C, and 310K, respectively. The four suction ducts 300Y. 300M. 300C, and 300K and the blowing ducts 310Y, 310M, 310C, and 310K correspond to the suction duct 300 and the blowing duct 310 described above. The four suction ducts 300Y, 300M, 300C, and 300K merge at the downstream side thereof, and are designed to share a suction fan and the like.

As described above, the suction ducts 300Y, 300M, 300C, and 300K (the suction ports 301) and the blowing ducts 310Y, 310M, 310C, and 310K (the blowing ports 311) are provided in the image formers 10Y, 10M, 10C, and 10K, respectively. Thus, the charged products generated in the respective charging devices 2Y, 2M, 2C, and 2K (the band electrodes 200) can be appropriately collected.

The image forming apparatus also includes cooling ducts 400, 410, 420, and 430 for cooling the four developing devices 4Y, 4M, 4C, and 4K. These cooling ducts 400, 410, 420, and 430 are all provided on the front side of the apparatus.

The YM cooling duct 400 cools the yellow and magenta developing devices 4Y and 4M, and is located between the developing devices 4Y and 4M. The MC cooling duct 410 cools the magenta and cyan developing devices 4M and 4C, and is located between the developing devices 4M and 4C. The CK cooling duct 420 cools the cyan and black developing devices 4C and 4K, and is located between the developing devices 4C and 4K.

Because the four image formers 10Y, 10M, 10C, and 10K are arranged in a vertical direction, the temperature of the yellow image former 10Y located at the uppermost position is likely to be high. Therefore, the Y cooling duct 430 is provided for the yellow developing device 4Y. The Y cooling duct 430 cools the yellow developing device 4Y, and is located above the yellow developing device 4Y.

These cooling ducts 400, 410, 420, and 430 each have a cooling blowing port (not shown), and air (cooling air) is blown from the respective cooling blowing ports. Air blown from the cooling blowing ports flows to the target developing devices 4Y, 4M, 4C, and 4K, and cools the developing devices 4Y, 4M, 4C, and 4K. In this case, the relationship. Qa<Qb≤Qc, is established, where “Qa” represents the volume of air from the YM cooling duct 400, “Qb” represents the volume of air from the MC cooling duct 410, and “Qc” represents the volume of air from the CK cooling duct 420. This is because there are situations where printing is performed only with black toner.

The air blown from the cooling blowing ports of the cooling ducts 400, 410, 420, and 430 also flows from the front side of the apparatus toward the rear side of the apparatus, while cooling the developing devices 4Y, 4M, 4C, and 4K. With this air flow, air additionally flows along each band electrode 200 from the one end thereof to the other end. Thus, the discharge products are effectively conveyed to the suction ducts 300Y, 300M, 300C, and 300K (the suction ports 301). As a result, air is not only sucked at the rear side of the apparatus but also blown from the front side of the apparatus, so that the discharge products staying on the band electrodes 200 can be appropriately collected.

Of the four suction ducts 300Y, 300M, 300C, and 300K, the yellow suction duct 300Y located on the upper side has a small suction air volume due to the influence of the fan static pressure. Therefore, the image former 10Y for yellow uses the air in the Y cooling duct 430 as well as the YM cooling duct 400, to effectively assist the suction of the discharge products.

In the case of the four image formers 10Y, 10M, 10C, and 10K, one or both of the opening area and the wind speed are set so that the suction air volume of each of the suction ducts 300Y, 300M, 300C, and 300K (the suction ports 301) becomes equal to or larger than the blowing air volume of a combination of each corresponding one of the blowing ducts 310Y, 310M, 310C, and 310K (the blowing ports 311) and each corresponding one of the cooling ducts 400, 410, 420, and 430.

As described above, in this embodiment, the image forming apparatus includes the band electrodes 200 that electrically charge the surface of the photosensitive drums 1, the suction ports 301 that suck air and eject the discharge products generated at the band electrodes 200, and the blowing ports (first blowing ports) 311 that blow air. The air blown from the blowing ports 311 flows along the band electrodes 200 from one end of the band electrodes 200 to the other end, and is sucked through the suction ports 301.

In this configuration, air is not only sucked at the other end of each band electrode 200 (the rear side of the apparatus), but also blown from the one end of each band electrode 200 (the front side of the apparatus). The air is then sucked through the suction ports 301. Thus, the discharge products staying on the band electrodes 200 can be appropriately collected. Further, in this configuration, there is no need to have the blowing ports 311 face the entire region of the band electrodes 200, and accordingly, the apparatus can be made smaller in size.

In this embodiment, the suction ports 301 are disposed at the other end of the band electrodes 200, and the blowing ports 311 are disposed the one end of the band electrodes 200.

In this configuration, air blown from the blowing ports 311 flows along the band electrodes 200 from the one end thereof to the other end, and is appropriately guided to the suction ports 301. Thus, discharge products can be efficiently collected. Further, the suction ports 301 and the blowing ports 311 are arranged at both sides of the band electrodes 200, and accordingly, the suction ducts 300 and the blowing ducts 310 can be disposed in a small space. Thus, the image forming apparatus can be made smaller in size.

Further, in this embodiment the blowing ports 311 blow air in a direction oblique to the band electrodes 200.

In this configuration, air is blown from the blowing ports 311 so as to flow along the band electrodes 200. Thus, the discharge products generated at the band electrodes 200 can be effectively conveyed to the suction ports 301.

Further, in this embodiment, air blown from the blowing ports 311 includes the first flow toward the band electrodes 200 and the second flow toward heat generators in the apparatus to cool the heat generators.

In this configuration, both the air for collecting discharge products and the air for cooling the heat generators can be blown from one blowing port 311. As a result, each blowing duct 310 can be shared, and accordingly, it is not necessary to prepare dedicated ducts for the respective flows. Thus, the image forming apparatus can be made smaller in size.

In this embodiment, the above mentioned heat generators are polygon motors for scanning light on the photosensitive drums 1 electrically charged by the band electrodes 200, but are not necessarily such polygon motors. The air for cooling other heat generators can be shared for collecting discharge products.

The image forming apparatus of this embodiment further includes the cooling blowing ports that are provided at the one end of the band electrodes 200 and blow cooling air to the developing devices 4. The cooling air blown from the cooling blowing ports flows from the one end of the band electrodes 200 to the other end, together with the air blown from the blowing ports 311, and is sucked through the suction ports 301.

In this configuration the air from the blowing ducts 310Y, 310M, 310C, and 310K can be assisted by the air for cooling the developing devices 4Y, 4M, 4C, and 4K. Thus, the discharge products staying on the band electrodes 200 can be collected more effectively.

Further, in this embodiment, one or both of the opening area and the wind speed are set so that the suction air volume at each suction port 301 becomes equal to or larger than the blowing air volume at each corresponding blowing port 311.

In this configuration, air blown from the blowing ports 311 is sucked through the suction ports 301, without staying inside. Thus, the discharge products staying on the band electrodes 200 can be appropriately collected.

### Second Embodiment

The following is a description of an image forming apparatus according to a second embodiment. The image forming apparatus according to the second embodiment differs from that of the first embodiment in the flow of air blown from the blowing ports 311, or more specifically, in switching the ratio between the first flow and the second flow. The same aspects as those of the first embodiment are not described herein, and the differences will be mainly described below.

In this embodiment, the ratio between the first flow and the second flow of air blown from a blowing port 311 can be switched. Examples of methods for switching the ratio between the first flow and the second flow will be described below.

According to a first method, blast fans compatible with the first flow and the second flow are respectively prepared. By this method, the air volumes of the respective blast fans are controlled, so that the ratio between the first flow and the second flow can be switched. The air volumes of the respective blast fans are controlled by the controller 70.

According to a second method, a movable switching gate 313 is provided in each blowing duct 310, as shown in FIG. 6. As this switching gate 313 is operated, the channel ratio in the blowing duct 310 is switched. By this method, the switching gate 313 is controlled, so that the ratio between the first flow and the second flow can be switched. The switching gate 313 is controlled by the controller 70.

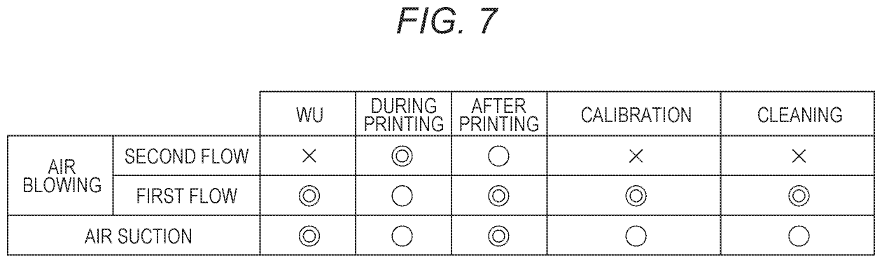

In this embodiment, the ratio between the first flow and the second flow can be switched in accordance with the conditions for operating the image forming apparatus. FIG. 7 shows a table for explaining the ratio between the first flow and the second flow. In the table, “x” means that blowing/suction is not necessary, and “⊙” means that blowing/suction is necessary. Meanwhile, “∘” means that it is desirable to have blowing/suction.

During the warming up (WU) period, polygon motor cooling is not necessary, and accordingly, the air blowing corresponding to the second flow is “x”. On the other hand, the load on the band electrodes 200 is small, and the amount of ozone generation is small. However, there is a possibility that some ozone remains around the band electrodes 200. Accordingly, the air blowing corresponding to the first flow, and the air suction at the suction port 301 are both “⊙”.

During printing, polygon motor cooling becomes necessary as the polygon motor is being driven. Although ozone is being generated at the band electrodes 200, the photosensitive drum 1 is also rotating, and therefore, adhesion to the photosensitive drum 1 hardly occurs. Accordingly, the air blowing corresponding to the second flow is “⊙”, and the air blowing corresponding to the first flow and the air suction at the suction port 301 are both “∘”.

After printing, on the other hand, the driving of the polygon motor is stopped, and accordingly, the necessity for cooling is low. The photosensitive drum 1 is also stopped, and the ozone generated at the band electrodes 200 is likely to adhere thereto. Accordingly, the air blowing corresponding to the second flow is “∘”, and the air blowing corresponding to the first flow and the air suction at the suction port 301 are both “⊙”.

Further, in a case where an image calibration operation is performed after printing is stopped, polygon motor cooling is not necessary, and accordingly, the air blowing corresponding to the second flow is “x”. On the other hand, there is the need to collect the ozone generated at the band electrodes 200, and therefore, the air blowing corresponding to the first flow is “⊙”. On the other hand, the air suction at the suction port 301 is not highly necessary, because the air auction will be resumed after printing is resumed. Accordingly, the air suction at the suction port 301 is “∘” during image calibration.

During a cleaning operation for cleaning the surface of the photosensitive drum 1, the ratio between the first flow and the second flow can be considered in the same manner as the image calibration operation.

As described above, according to this embodiment, the ratio between the first flow and the second flow can be switched in accordance with the conditions for operating the image forming apparatus.

In this configuration, discharge product collection and polygon motor cooling can be performed in a well-balanced manner.

In this embodiment, methods for switching the ratio between the first flow and the second flow in accordance with the conditions for operating the image forming apparatus have been described. However, in a case where an image defect has occurred, air may be blown from the blowing ports 311 in accordance with a user instruction.

In each of the above described embodiments, the respective blowing ports 311 are provided for the four image formers 10Y, 10M, 10C, and 10K. However, one or more blowing ports 311 may be provided for one or more of the four image formers 10Y, 10M, 10C, and 10K.

Further, in the above embodiments, the blowing ports 311 for collecting discharge products are formed with the blowing ducts 310 for cooling the polygon motors. However, blowing ports may be formed with the cooling ducts 400, 410, 420, and 430 for cooling the developing devices 4. In this case, the air for collecting discharge products may be additionally blown out from the blowing ducts 310 that cool the polygon motors.

Although image forming apparatuses according to embodiments of the present invention have been described so far, the present invention is not limited to the above described embodiments, and various modifications may of course be made to them within the scope of the invention.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming apparatus comprising:
a band electrode that electrically charges a surface of a photoreceptor, the band electrode being disposed along an axial direction of the photoreceptor;
a suction port that sucks air and ejects a discharge product generated at the band electrode; and
a first blowing port that blows air,
wherein the air blown from the first blowing port flows along the band electrode from one end of the band electrode toward the other end, and is sucked through the suction port.

2. The image forming apparatus according to claim 1, wherein
the suction port is disposed at the other end of the band electrode, and
the first blowing port is disposed at the one end of the band electrode.

3. The image forming apparatus according to claim 2, wherein the first blowing port blows air in a direction oblique to the band electrode.

4. The image forming apparatus according to claim 1, wherein the air blown from the first blowing port includes:
a first flow toward the band electrode; and
a second flow toward a heat generator in the apparatus, the second flow being for cooling the heat generator.

5. The image forming apparatus according to claim 4, wherein the heat generator is a polygon motor for scanning light on the photoreceptor electrically charged by the band electrode.

6. The image forming apparatus according to claim 1, further comprising:
a developing device that develops the photoreceptor with a developer, and
a second blowing port that is provided at the one end of the band electrode, and blows cooling air to the developing device, and
wherein the cooling air blown from the second blowing port flows from the one end of the band electrode to the other end, together with the air blown from the first blowing port, and is sucked through the suction port.

7. The image forming apparatus according to claim 1, wherein at least one of an opening area and a wind speed is set to adjust a suction air volume at the suction port to a volume not smaller than a blowing air volume at the first blowing port.

8. The image forming apparatus according to claim 1, wherein
the band electrode is mounted on each image former of a plurality of image formers that form images in different colors from one another, and
the first blowing port is provided for at least one image former of the plurality of image formers.

9. The image forming apparatus according to claim 4, wherein a ratio between the first flow and the second flow is switched in accordance with a condition for operating the image forming apparatus.

10. The image forming apparatus according to claim 9, further comprising
a fan that blows air from the first blowing port,
wherein a volume of air being blown from the fan is controlled, to switch the ratio between the first flow and the second flow.

11. The image forming apparatus according to claim 9, further comprising
a switching gate that switches the ratio between the first flow and the second flow,
wherein the switching gate is controlled, to switch the ratio between the first flow and the second flow.

12. The image forming apparatus according to claim 1, wherein, when an instruction from a user is received, air is blown from the first blowing port.
